(19) United States
(12) Patent Application Publication
(10) Pub. No.: US 2005/0044829 A1
(43) Pub. Date: Mar. 3, 2005

(54) Filter rack

(75) Inventor: Thomas Dale Chase, Derby, KS (US)

Correspondence Address: MCNEES, WALLACE & NURICK LLC, 100 PINE STREET, P.O. BOX 1166, HARRISBURG, PA, 17108-1166, US

(73) Assignee: York International Corporation, York, PA (US)

(21) Appl. No.: 10/717,825

(22) Filed: Nov. 20, 2003

Related U.S. Application Data
(60) Provisional application No. 60/498,783, filed on Aug. 29, 2003.

(51) Int. Cl. B01D 46/00

(52) U.S. Cl. 55/495

(57) ABSTRACT

The subject matter under consideration is directed to filter racks that can be assembled and installed to hold filters and filter elements in a forced air-circulating environment such as a heating and air conditioning system. The filter rack has longitudinal members that are assembled to form a rectangular frame using readily available hardware. The longitudinal members include two side members and a back member, preferably made from the same material and having the same cross sectional profile, as well as a front member and a door. The cross-sectional profile of the side members, back member, and the front member include flanges to provide a filter rack that can receive and retain a rectangular filter when assembled.

### CROSS REFERENCE TO RELATED APPLICATIONS

This application claims priority to U.S. Provisional Patent Application No. 60/498,783 filed Aug. 29, 2003.

### FIELD OF THE INVENTION

The subject matter of the invention under consideration is directed to a filter rack that can be assembled and installed to securely and removably retain a filter and filter element in a forced air-circulating environment such as a heating and air conditioning system.

### BACKGROUND OF THE INVENTION

Filter racks are provided in commercial and residential forced air circulating systems, such as heating ventilation and air conditioning (“HVAC”) systems, to house or hold filters. Filters are used in HVAC systems to remove allergens and other pollutants to ensure good air quality. Some types of filters include flat filter assemblies made from corrugated paper and other porous materials.

Installation and operation of HVAC systems requires an extensive network of positive flow air flow ducting that carries circulating air throughout the building, as well as return air flow ducting which returns air from the building to the furnace or air conditioner for heating, cooling, or other conditioning and recirculation. Such ducting is typically rectangular in cross section, and formed from sheet metal such as aluminum or galvanized steel. Filters are commonly provided at the terminus of the return air flow ducting so that air is filtered before re-entering the air intake for the furnace or air conditioner. Such filters are held by racks that are positioned between the ducting and the air intake.

The design and configuration of filter racks can vary from system to system. Some filter racks are built into the housing of the air conditioner or furnace, while others are designed to be installed in, and attached, to the return air flow ducting. One drawback of many filter racks is that they are made from steel, which has poor anti-corrosion properties and is therefore not suitable for humidified air supplies. Moreover, most filter racks are crudely assembled and installed in the field. For example, overlapping long metal strips are positioned to form a comer, and then screws are driven through the overlapping strips to fasten them in place. These inferior assemblies and methods result in filter racks having non-square comers, comer gaps, excessive vibration, low corrosion resistance, and other undesirable qualities. As a result, remedial measures, such as application of duct tape or caulking material to comers and surrounding ductwork, are commonly necessary. Such remedial measures result in only marginal improvements, and require additional labor on installation, and additional maintenance or replacement costs throughout the service life of the system.

Therefore, what is needed is a filter rack for insertion into ductwork of a forced air circulating system that can be easily assembled and that provides a rigid, corrosion-resistant and air tight assembly.

### SUMMARY OF THE INVENTION

The present invention provides a filter rack for a forced air-circulating system, the filter rack comprising a plurality of longitudinal members having flanges adapted to receive and retain a filter and having channels adapted to receive and retain a connector, each longitudinal member adapted for connection to at least one other longitudinal member to form a rectangular frame; and a plurality of connectors adapted for insertion into the channels for connecting each longitudinal member to at least one other longitudinal member.

The present invention further provides a method of assembling a filter rack for a forced air-circulating system, the method comprising the steps of providing a plurality of longitudinal members, each longitudinal member having flanges adapted to receive and retain a filter and having channels adapted to receive and retain at least one connector, each longitudinal member adapted for connection to at least one other longitudinal member to form a rectangular frame, the longitudinal members comprised of a front, at least two sides, and a back; providing a plurality of connectors adapted for insertion into the channels for connecting each longitudinal member to at least one other longitudinal member; and connecting each longitudinal member to at least one other longitudinal member using the plurality of connectors so as to form a rectangular frame.

One advantage of the instant invention is that it provides a filter rack that is adapted for easy and reliable assembly and installation into a forced air-circulating system using only hand tools, such as a screwdriver. Another advantage is that the filter rack components are simple and inexpensive to manufacture, such as by aluminum extrusion methods that produce lightweight, corrosion resistant components having consistent and reproducible qualities. Still another advantage is that the filter rack can be packaged and shipped unassembled in component or kit form, thereby saving shipping space and associated costs.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a three-quarter top view of an embodiment of the filter rack of the present invention.

FIG. 2 is an exploded view of a corner of the filter rack of FIG. 1, illustrating the preferred connector apparatus and comer assembly.

FIG. 3 is a cross sectional view of a side member taken along line III-III of FIG. 1.

FIG. 4 is a cross sectional view of the front member taken along line IV-IV of FIG. 1.

FIG. 5 is a cross sectional view of the door member taken along line V-V of FIG. 1.

Wherever possible, the same reference numbers will be used throughout the drawings to refer to the same or like parts.

### DETAILED DESCRIPTION OF THE INVENTION

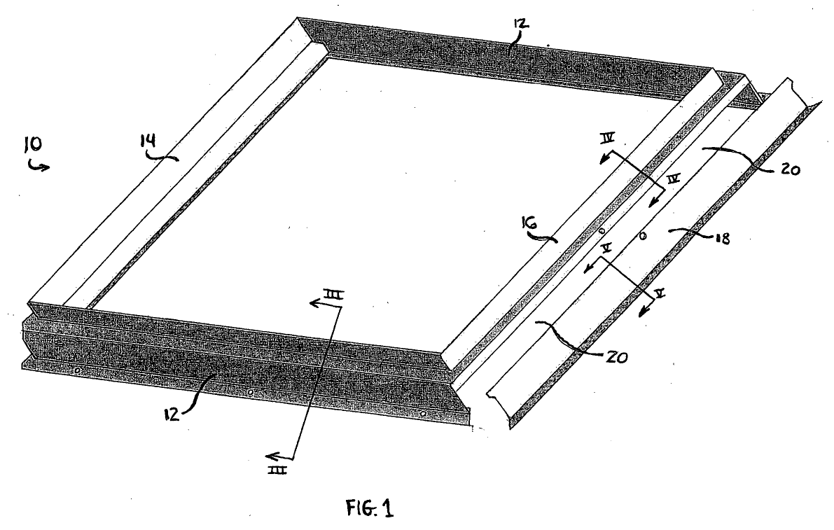

FIG. 1 illustrates one embodiment of the filter rack 10 of the present invention. The filter rack 10 has a substantially rectangular shape, when assembled, and is formed from a plurality of longitudinal members, which include two substantially parallel side members 12, a back member 14 substantially perpendicular to the side members 12, and a front member 16 opposite the back member 14 and substantially perpendicular to the side members 12. The side members 12, back member 14, and front member 16 are made or formed from an extruded rigid material such as plastic, composites, aluminum, or corrosion-resistant coated metal. More preferably, the rigid material used to form the side members 12, back member 14, and front member 16 is extruded aluminum. FIG. 1 further illustrates that the filter rack 10 has a door 18 that can be mated with or assembled to the front member 16, and possibly the side members 12, to form a substantially airtight connection. The door 18 can be attached to the front 16, and possibly also to one or both of the side members 12, by any suitable detachable connecting system or technique, such as screws, bolts, hook and loop type fasteners, tabs, clamps, hinges and the like. Preferably the door 18 is attached using at least one bolt passing through an aperture in the front member 16 and through a corresponding aperture in the door 18, the bolt is removably secured by at least one wing nut that can be accessed from the outer perimeter of the assembled filter rack 10.

As shown in FIG. 1, the front member 16 of the filter rack 10 is configured so as to provide an opening 20 for a filter (not shown) to be inserted into a receiving channel to pass into the filter rack and engage flanges 102, 104 in the front member 16, side members 12 and back member 14.

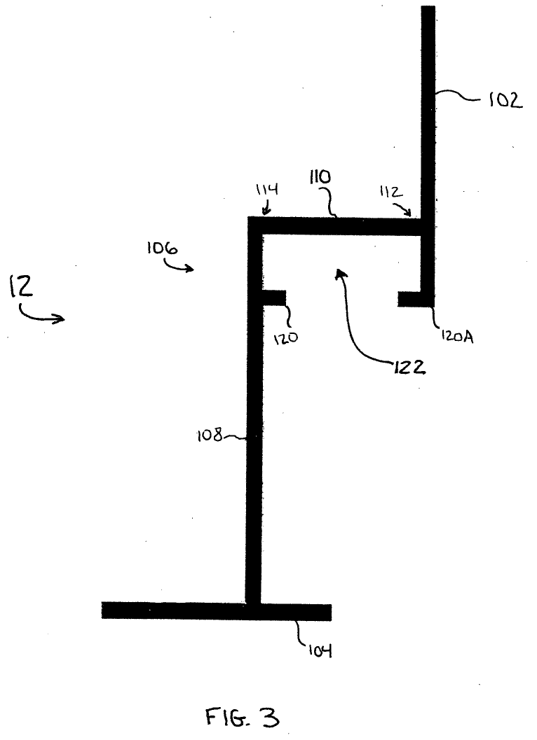

FIG. 3 illustrates the cross-sectional profile of a side member 12. In a preferred embodiment of the present invention, both side members 12 and the back member 14 have the same cross sectional profile as illustrated in FIG. 3. The side member 12 has a first flange member 102, a second flange member 104 perpendicular to the first flange member 102, and a “L” shaped member 106 connecting the first flange member 102 and the second flange member 104. The “L” shaped member 106 has a first linear section 108 that is attached to the second flange 104 and is aligned substantially perpendicular to the second flange 104. The “L” shaped member 106 further includes a second linear section 110 having a first end 112 end attached to the first flange 102, and an opposite end 114 attached to the first linear section 108. In one embodiment, the first linear section 108 and second linear section 110 are one continuous piece. The second linear section 110 is aligned substantially perpendicular to the first flange 102 and the first linear section 108. The first linear section 108 further includes a protruding flange or ridge 120 that is disposed substantially perpendicular to the first linear section 108. The protruding ridge 120 is disposed opposite a corresponding protruding ridge 120A located on the end of the first flange member 102, the protruding flanges 120, 120A and the second linear section 110 form a rectangular channel 122 in the side member 12 (and back member 14) that can be used to receive connecting hardware. The first flange member 102 and second flange member 104 are adapted for mounting into an air handling system. Preferably, the second flange member 104 contains mounting means such as mounting holes 128 for attachment to ductwork or air handling equipment.

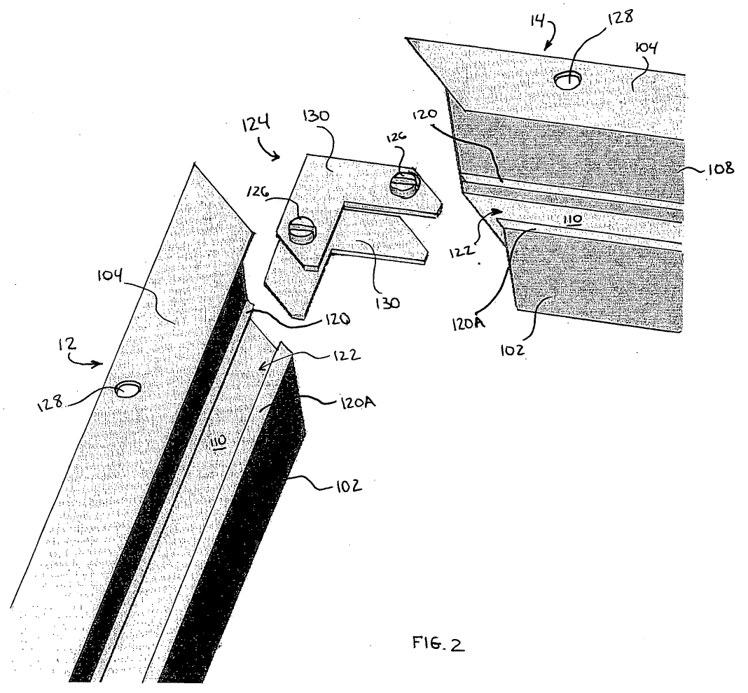

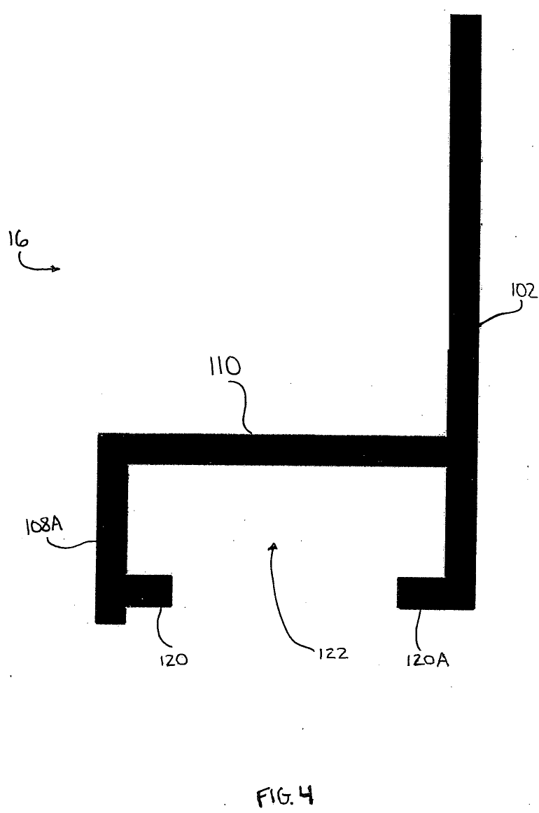

FIG. 4 shows a cross-section of a preferred embodiment of the front member 16 for use in conjunction with the side members 12 and back member 14 as illustrated in FIG. 2. The front member 16 contains a first flange member 102 connected to an “L”-shaped member having an abbreviated first linear section 108A, the first linear section 108A and first flange member 102 are connected by a second linear section 110 that is substantially perpendicular to the first linear section 108A and first flange member 102. The first linear section 108A further includes a protruding flange 120 that is disposed substantially perpendicular to the first linear section 108A. The protruding ridge 120 is disposed opposite a corresponding protruding flange 120A located on the end of the first flange member 102, the protruding flanges 120, 120A and the second linear section 110 form a rectangular channel 122 that can be used to receive connecting hardware.

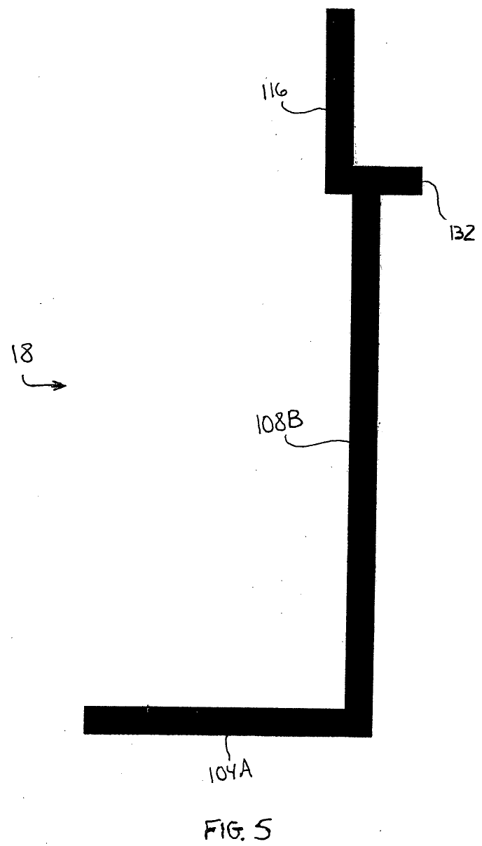

FIG. 5 shows a cross-section of a preferred embodiment of the door 18 for use in conjunction with the side members 12 and back member 14 as illustrated in FIG. 2, and with the front member 16 as illustrated in FIG. 4. The door 18 has a flange member 104A connected to one end of an abbreviated first linear section 108B, and an “L”-shaped portion 116 connected to the opposite end of the abbreviated first linear section 108B. The abbreviated linear section 108B contains a protruding flange 132 that is disposed substantially perpendicular to the abbreviated linear section 108B. The flange 132 and “L”-shaped portion 116 are arranged and configured so that the door 18 can be mated to the front member 16 to form an airtight assembly. When mated, the cross-sectional profile of the connected door 18 of FIG. 5 and front member 16 of FIG. 4 have a collective cross-sectional profile substantially similar to that of the side members 12 and back members 14 illustrated in FIG. 3.

The hardware used to assemble the filter rack may include one or more connectors 124 (see FIG. 2) for joining the longitudinal members to form a rectangular frame. In the preferred embodiment shown in FIG. 2, each longitudinal member is adapted for interconnection with other longitudinal members, such as by including ends cut at 45 degree angles, and including at least one channel 122 for securely receiving connectors 124. Preferably, the connectors 124 are flat L-shaped connectors 124 having one or more connector plates 130, each connector plate 130 having at least two leg portions. However, any connector 124 which can attach two longitudinal members to form a 90 degree angle can be used, such as, for example, a flat connector bent to form a 90 degree angle, or any other suitable comer hardware.

In the embodiment illustrated in FIG. 2, fasteners 126 such as one or more screws or bolts threaded through each leg of a connector plate 130 are used to secure the connector plate 130 in the channel 122 to connect the longitudinal members. To connect two longitudinal members at right angles, one leg of each connector plate 130 is inserted into a channel 122 in one longitudinal member. The channel 122 is shaped and sized to securely receive and retain the leg and is preferably a substantially “U”-shaped channel formed by one or more protruding ridges 120, 120A extending over the channel 122 to prevent the connector plate 130 from leaving the channel 122. The remaining leg of the connector plate 130 is inserted into a corresponding channel 122 in another longitudinal member to form a corner. Each connector plate 130 leg is then secured, preferably by adjusting the fastener 126 to move and position the fastener 126 against the face of the first linear section 110, (or a second connector plate 130) and forcing the connector plate 130 upwards until the rear face of the connector plate 130 contacts at least one ridge 120, 120A to frictionally and securely engage each connector plate 130 leg in its respective channel 122, thereby forming a framed corner. Alternative embodiments contemplated hereunder permit use of any available corner hardware and corresponding receiving configuration incorporated in the longitudinal members. For example, tapered connectors or connectors having high-friction surface edges can be used to frictionally engage correspondingly-sized channels in the longitudinal members so as to eliminate the need for fasteners 126 such as threaded bolts or screws in the connector 124. In still another embodiment, the fasteners 126 can be positioned through the plate and longitudinal member to form a connection, such as by inserting a screw through corresponding holes in the connector and the member.

In one embodiment, the disclosed invention is a fully assembled rectangular filter rack which can be installed in heating and air conditioning systems to securely house one or more rectangular filters. In another embodiment, the disclosed invention can be provided disassembled in a filter rack kit that includes the back 14, side 12, and front 16 members, the door 18, and a plurality of connectors 24 sufficient to form a rectangular filter rack when assembled.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A filter rack for a forced air-circulating system, the filter rack comprising:
a plurality of longitudinal members having flanges adapted to receive and retain a filter and having channels adapted to receive and retain a connector, each longitudinal member adapted for connection to at least two other longitudinal member to form a rectangular frame;
a plurality of connectors adapted for insertion into corresponding channels of the longitudinal member for connecting each longitudinal member to at least one other longitudinal member.

2. The filter rack of claim 1, wherein the longitudinal members are comprised of a back member, at least two side members, and a front member.

3. The filter rack of claim 2, wherein the front member is configured to provide an opening to permit a filter to pass into the assembled filter rack and to be received and retained by flanges on the longitudinal members.

4. The filter rack of claim 3, wherein the longitudinal members are comprised of a corrosion-resistant rigid material.

5. The filter rack of claim 4, wherein the corrosion-resistant rigid material is selected from the group consisting of: plastic, composites, aluminum, and coated metal.

6. The filter rack of claim 5, wherein the rigid material is formed by extrusion to produce a longitudinal member having a predetermined cross-sectional profile.

7. The filter rack of claim 6, wherein the connectors are comprised of picture frame hardware.

8. The filter rack of claim 6, wherein the connectors are flat L-shaped connectors, and wherein the channel is provided in the rear face of each longitudinal member.

9. The filter rack of claim 8, wherein the connector further includes at least one fastener.

10. The filter rack of claim 9, wherein the at least one fastener is selected from the group consisting of bolts, screws, tabs, hook and loop type fasteners, clamps, caulking, clamps, and adhesives.

11. The filter rack of claim 8, wherein the filter rack is further comprised of a door that is attached to the at least one longitudinal member by removable attachment means.

12. The filter rack of claim 9, wherein the filter rack is further comprised of a door that is attached to at least two longitudinal members by removable attachment means.

13. The filter rack of claim 11, wherein the removable attachment means is selected from the group consisting of screws, bolts, hook and loop type fasteners, tabs, clamps, and hinges.

14. A method of assembling a filter rack for a forced air-circulating system, the method comprising:
providing a plurality of longitudinal members, each longitudinal member having flanges adapted to receive and retain a filter, and having channels adapted to receive and retain at least one connector, each longitudinal member adapted for connection to at least one other longitudinal member form a rectangular frame, the longitudinal members comprised of a front, at least two sides, and a back;
providing a plurality of connectors adapted for insertion into the channels for connecting each longitudinal member to at least one other longitudinal member; and
connecting each longitudinal member to at least one other longitudinal member using the plurality of connectors so as to form a rectangular frame.

15. The method of claim 14, the method further comprising the step of:
providing a door adapted for removable attachment to at least one longitudinal member; and
attaching the door adapted to at least one longitudinal member.

16. The method of claim 14, the method further comprising the step of:
providing a door adapted for removable attachment to at least two longitudinal members; and
attaching the door to at least two longitudinal members.

17. A forced air-circulating system comprised of:
return air flow ducting having a rectangular cross-sectional geometry;
a filter rack connected to the return flow ducting, the filter rack comprising:
a plurality of longitudinal members having flanges adapted to receive and retain a filter and having channels adapted to engage and retain a connector, the longitudinal members comprised of a back member, at least two side members, and a front member, wherein the front member is configured to provide an opening to permit a filter to pass into the assembled filter rack and to be received and retained by flanges on the longitudinal members, each longitudinal member adapted for connection to at least two other longitudinal member to form a rectangular frame;
a plurality of connectors inserted into corresponding channels of individual longitudinal members for connecting each longitudinal member to at least one other longitudinal member;
wherein the connectors are flat L-shaped connectors.

18. The forced air-circulating system of claim 17, wherein each connector further includes at least one fastener.

19. The forced air-circulating system of claim 18, wherein the at least one fastener is selected from the group consisting of bolts, screws, tabs, hook and loop type fasteners, clamps, caulking, clamps, and adhesives.

20. The forced air-circulating system of claim 19, wherein the filter rack is further comprised of a door that is attached to at least one longitudinal member by removable attachment means.
